(19) United States
(12) Patent Application Publication
(10) Pub. No.: US 2014/0326659 A1
(43) Pub. Date: Nov. 6, 2014

(54) Preparation method of enhanced-type polyacrylonitrile hollow fiber membrane

(71) Applicant: TIANJIN POLYTECHINC UNIVERSITY, Tianjin (CN)

(72) Inventors: Changfa Xiao, Tiangjin (CN); Rui Wang, Tianjin (CN); Meitian Liu, Tianjin (CN); Shulin An, Tianjin (CN)

(21) Appl. No.: 14/358,607

(22) PCT Filed: Jan. 24, 2013
(86) PCT No.: PCT/CN2013/000073

§ 371 Date: May 15, 2014

(30) Foreign Application Priority Data
Mar. 2, 2012 (CN) 201210051804.5

(51) Int. Cl. B01D 69/08; B01D 67/00; B01D 71/42

(52) U.S. Cl. CPC B01D 69/088; B01D 71/42; B01D 67/0011; B01D 2325/40
USPC 210/500.23; 264/103

(57) ABSTRACT

A preparation method of an enhanced-type polyacrylonitrile hollow fiber membrane comprises steps of: (1) knitting a polyacrylonitrile fiber hollow braided tube by a two-dimensional weaving technology; wherein the polyacrylonitrile fiber hollow braided tube is utilized as a reinforcement of a hollow fiber membrane; (2) preparing polyacrylonitrile casting solution, wherein, polyacrylonitrile resin is 3%-25%; solvent is 50%-95%; and additive is 2%-30%; a sum of the mass percent of all composition mentioned above is 100%; (3) infiltrating the polyacrylonitrile fiber hollow braided tube by weak polar organic liquid, wherein, a time of the polyacrylonitrile fiber hollow braided tube infiltrated is is-60s; the weak polar organic liquid is ethanol, glycerol, isopropanol, or polyethylene glycol (PEG)-600; (4) processing the polyacrylonitrile fiber hollow braided tube and the polyacrylonitrile casting solution with a coextrusion by an annular spinneret; fully solidifying the polyacrylonitrile fiber hollow braided tube and the polyacrylonitrile casting solution in coagulation bath; in such a manner that an enhanced-type polyacrylonitrile hollow fiber membrane is obtained.

### CROSS REFERENCE OF RELATED APPLICATION

This is a U.S. National Stage under 35 U.S.C. 371 of the International Application PCT/CN2013/000073, filed Jan. 24, 2013, which claims priority under 35 U.S.C. 119(a-d) to CN 201210051804.5, filed Mar. 2, 2012.

### BACKGROUND OF THE PRESENT INVENTION

1. Field of Invention

The present invention relates to the field of membrane preparation technology, and more particularly to a preparation method of enhanced-type polyacrylonitrile hollow fiber membrane.

2. Description of Related Arts

Since polyacrylonitrile has characteristics of organic solvent resistance, lightfastness, weatherability, fungal resistance, good chemical stability, thermal stability, processability of the membrane produced by the solution spinning method, wide source, and low cost, the polyacrylonitrile is a satisfying membrane-forming material.

Along with the wider and wider application scope of the hollow fiber membrane, requirements for its performances are raised to be higher and higher. However, conventional single layer hollow fiber membrane cannot completely meet demands of application and development of the membrane separation technology, for example, the membrane produced by the solution spinning method has poor mechanical property. The heterogeneous enhanced-type polyvinylidene fluoride (PVDF) hollow fiber membrane provides a new approach to improve the mechanical property of conventional hollow fiber membrane produced by the solution spinning method, wherein a hollow tubular braided fabric or a woven fabric of polyester fiber or polyamide fiber is utilized as a reinforcement; the reinforcement is coated with PVDF casting solution; after compounding and solidifying the reinforcement with the PVDF casting solution to form the external separation layer; the external separation layer and the reinforcement are formed by different substances to form the heterogeneous enhanced-type polyvinylidene fluoride hollow fiber membrane. At present, the heterogeneous enhanced-type PVDF hollow fiber membrane has been widely applied in the membrane bioreactor (MBR) technology for treating sewage, but the external separation layer and the reinforcement are formed by different substances with poor interfacial bounding condition, so the reliability of the membrane operation system is poor.

At present, main methods for enhancing the layer-to-layer interfacial bounding strength of the enhanced-type hollow fiber membrane are described as follows.

### Method 1

A reinforcement is completely wrapped in a hollow fiber membrane, so as to increase an interfacial bounding strength. For example, a Chinese patent with an publication number CN1695777A provides a method comprising one step of: spinning the hollow fiber membrane by processing a reinforcing fiber and casting solution with co-extrusion. The method makes the reinforcing fiber to be longitudinally wrapped in a wall of the hollow fiber membrane, which is capable of effectively enhancing an axial anti-tensile property of the hollow fiber membrane, but a radial anti-compaction performance of the hollow fiber membrane is not enhanced obviously. A Chinese patent with a publication number of CN1864828A provides a method comprising steps of: spinning a hollow fiber membrane utilizing casting solution; dipping a mesh that is spun outside the hollow fiber membrane by a synthetic fiber into the casting solution; coagulating the hollow fiber membrane with the mesh by coagulation bath, so as to form a reticular braided fabric to enhance the hollow fiber membrane; wherein the reticular braided fabric is wrapped in the wall of the hollow fiber membrane, for improving a mechanical property of the hollow fiber membrane. However, in the process of using the hollow fiber membrane, when the hollow fiber membrane swings, the reinforcement will lengthen and shorten accordingly, which causes that the structure of the reinforcement is damaged. If the reinforcement lengthens and shortens excessively, the physical damage of the external separation layer of the hollow fiber membrane can not be recovered, which causes that the effect of the separation system of the hollow fiber membrane is lost.

### Method 2

A transition layer is added between a reinforcement and an external separation layer of a hollow fiber membrane, so as to improve an interfacial bounding strength. For example, a patent with a publication number of US7165682 provides a method comprising steps of: coating an adhesive on a hollow braided fabric; covering casting solution on the hollow braided fabric; wherein a function of the adhesive is to improve an interfacial bounding strength between the external separation layer and the enhancement layer. However, the method mentioned above has a problem of the compatibility between layers; although a smooth interface is formed by coagulating the transition layer, the bounding strength of the external separation layer and the transition layer still cannot get a satisfactory improvement.

Problems of technical schemes mentioned above lie in that materials of the reinforcement are terylene, nylon, or polyamide (PA), which are different from materials of the external separation layer of PVDF or polyacrylonitrile, so the reinforcement and the external separation layer have the compatibility difference. Although a series of improved methods are taken, the method of heterogeneous enhancement limits the interfacial bounding strength, so in the process of shaking in a high strength and backwashing, the external separation layer is easy to strip from the surface of the reinforcement, which seriously shortens the service life of the hollow fiber membrane.

### SUMMARY OF THE PRESENT INVENTION

In view of disadvantages in conventional art, an object of the present invention is to provide a preparation method of an enhanced-type polyacrylonitrile hollow fiber membrane. Through a method of a homogeneous enhancement, the preparation method provides the enhanced-type polyacrylonitrile hollow fiber membrane prepared thereby with an excellent mechanical property, and a high interfacial bounding strength. Meanwhile, the preparation method is simple and is easy to be operated, which is suitable for industrialized production.

A technical scheme of the present invention is to design a preparation method of an enhanced-type polyacrylonitrile hollow fiber membrane to solve technical problems of the preparation method, and the preparation method thereof comprises steps of:

(1). knitting a polyacrylonitrile fiber reinforcement, comprising a step of:

knitting the polyacrylonitrile fiber to be a polyacrylonitrile fiber hollow braided tube by a two-dimensional weaving technology;

wherein the polyacrylonitrile fiber hollow braided tube is utilized as the reinforcement of a hollow fiber membrane;

(2). preparing polyacrylonitrile casting solution, comprising a step of:

mixedly dissolving polyacrylonitrile resin and additive in solvent;

wherein, a system of the polyacrylonitrile casting solution comprises:

the polyacrylonitrile resin: 3%-25% in mass fraction;

the solvent: 50%-95% in mass fraction;

and the additive: 2%-30% in mass fraction;

wherein a sum of the mass fraction of all composition mentioned above is 100%;

wherein the polyacrylonitrile resin is conventional fiber-forming polyacrylonitrile resin; the solvent is a good type solvent of polyacrylonitrile selected from a group consisting of N,N-dimethylformamide (DMF), N,N-dimethylacetamide, dimethyl sulfoxide (DMSO), N-Methyl-2-pyrrolidone (NMP), and aqueous solution of sodium thiocyanate of 55wt %; the additive is water-soluble components, which is mixed solution of polyethylene glycol (PEG) or polyvinylpyrrolidone (PVP) accounting for 2%-25% of the total mass of the system of the polyacrylonitrile casting solution and Tween 80 accounting for 0%-10% of the total mass of the system of the polyacrylonitrile casting solution;

(3). preprocessing a surface of a reinforcement, comprising a step of:

infiltrating the polyacrylonitrile fiber hollow braided tube prepared in the Step (1) by weak polar organic liquid, in such a manner that an external surface of the polyacrylonitrile fiber hollow braided tube is fully infiltrated, wherein an infiltrating time of the polyacrylonitrile fiber hollow braided tube is 1 s-60 s;

wherein the weak polar organic liquid is ethanol, glycerol, isopropanol, or polyethylene glycol (PEG)-600; and

(4). preparing a hollow fiber membrane, comprising steps of:

processing the polyacrylonitrile fiber hollow braided tube obtained in the Step (3) and the polyacrylonitrile casting solution prepared in the Step (2) with a coextrusion by an annular spinneret, according to a sheath-core composite spinning technology, in such a manner that the polyacrylonitrile casting solution is equably coated on a surface of the polyacrylonitrile fiber hollow braided tube;

processing the polyacrylonitrile fiber hollow braided tube by air bath for 0 s-480 s;

dipping the polyacrylonitrile fiber hollow braided tube in coagulation bath of 10° C.-65° C.; and

fully solidifying the polyacrylonitrile fiber hollow braided tube, in such a manner that an enhanced-type polyacrylonitrile hollow fiber membrane is obtained;

wherein media of the coagulation bath is water, or the aqueous solution of the solvent;

wherein a scope of a mass percent of the solvent is 0%-100%.

Comparing with conventional technology, the preparation method of the enhanced-type polyacrylonitrile hollow fiber membrane of the present invention uses a method of a homogeneous enhancement or a method of a noumenal enhancement, i.e., a membrane-forming material of casting solution and material of a hollow braided tube utilized as a reinforcement are both polyacrylonitrile, so a matrix phase material of an internal layer of a membrane obtained and a matrix phase material of an external layer of the membrane obtained do not have a compatibility difference, so that the internal layer and the external layer combine closer, have an excellent interfacial bounding condition, and a high interfacial bounding strength. The preparation method of the enhanced-type polyacrylonitrile hollow fiber membrane provides the enhanced-type polyacrylonitrile hollow fiber membrane with not only a high breaking strength (>400 N) but also a high peel strength, which not only effectively improves a mechanical property of the enhanced-type polyacrylonitrile hollow fiber membrane, but also prolonges a service life of the enhanced-type polyacrylonitrile hollow fiber membrane, wherein obsoleted membrane materials are easy to be recycled, because parts of the obsoleted membrane materials processed can be used to prepare plastic products. In the scope of pre-searching, the applicant has not found any report of a homogeneous enhanced-type hollow fiber membrane.

These and other objectives, features, and advantages of the present invention will become apparent from the following detailed description, the accompanying drawings, and the appended claims.

### BRIEF DESCRIPTION OF THE DRAWINGS

FIG. 1 is a structure diagram of a cross section of an enhanced-type polyacrylonitrile hollow fiber membrane of the present invention, according to a preferred embodiment of the present invention, wherein a black internal circle part represents a hollow braided tube utilized as a reinforcement knitted by polyacrylonitrile fiber, and a white external circle part represents a polyacrylonitrile hollow fiber membrane.

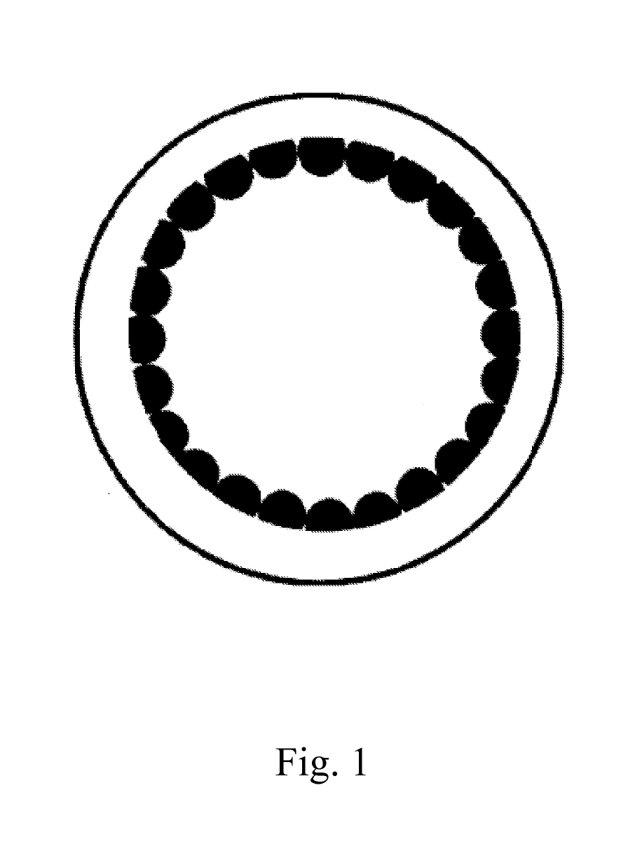

FIG. 2 is an overall three-dimensional structure diagram of the enhanced-type polyacrylonitrile hollow fiber membrane of the present invention, according to the preferred embodiment of the present invention, wherein the small picture is an external structure diagram of the hollow braided tube utilized as the reinforcement.

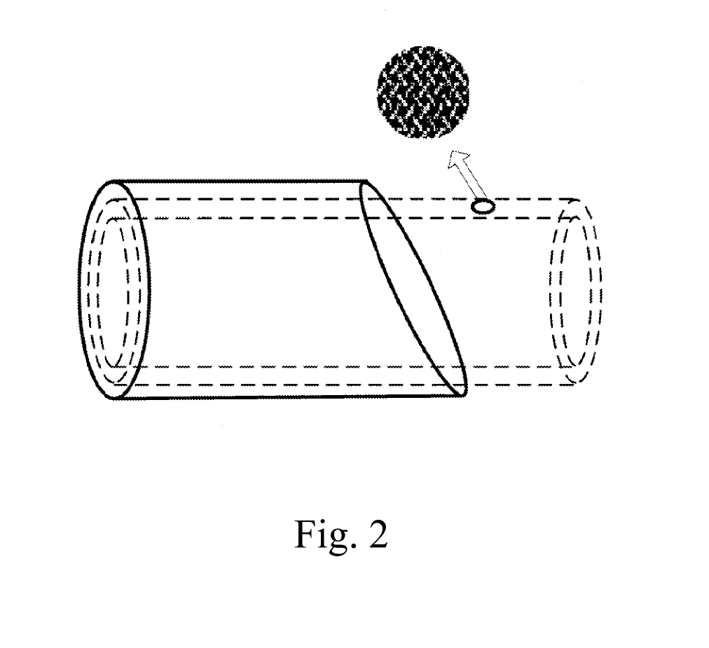

### DETAILED DESCRIPTION OF THE PREFERRED EMBODIMENT

Combining with the preferred embodiments, the present invention is described in detail as follows.

The present invention designs a preparation method of an enhanced-type polyacrylonitrile hollow fiber membrane, comprising steps of:

(1) knitting a polyacrylonitrile fiber reinforcement, comprising a step of:

knitting polyacrylonitrile fiber to be a polyacrylonitrile fiber hollow braided tube by a two-dimensional weaving technology; wherein the polyacrylonitrile fiber hollow braided tube is utilized as a reinforcement of a hollow fiber membrane;

wherein the polyacrylonitrile fiber is conventional polyacrylonitrile continuous fiber (filament), or polyacrylonitrile staple fiber yarn;

(2) preparing polyacrylonitrile casting solution, comprising steps of:

mixedly dissolving polyacrylonitrile resin and additive in solvent;

wherein, a system of the polyacrylonitrile casting solution comprises:

the polyacrylonitrile resin: 3%-25% in mass fraction;

the solvent: 50%-95% in mass fraction;

and the additive: 2%-30% in mass fraction;

wherein a sum of the mass percent of all composition mentioned above is 100%;

wherein, preferably, the system of the polyacrylonitrile casting solution comprises:

the polyacrylonitrile resin: 7%-14% in mass fraction;

the solvent: 70%-89% in mass fraction;

and the additive: 4%-16% in mass fraction;

wherein a sum of the mass percent of all composition mentioned above is 100%;

wherein, the polyacrylonitrile resin is conventional fiber-forming polyacrylonitrile resin; the solvent is a good type solvent of polyacrylonitrile, which is selected from a group consisting of N,N-dimethylformamide (DMF), N,N-dimethylacetamide, dimethyl sulfoxide (DMSO), N-Methyl-2-pyrrolidone (NMP), and aqueous solution of sodium thiocyanate of 55 wt %; the additive is various water-soluble components, which is mixed solution of polyethylene glycol (PEG) polyvinylpyrrolidone (PVP) and Tween 80; specifically, the additive is the PEG accounting for 2%-25% of the total mass of the system of the polyacrylonitrile casting solution, or the mixed solution that is mixed by the PVP and the Tween 80 accounting for 0%-10% of the total mass of the system of the polyacrylonitrile casting solution; preferably, the PEG accounting for 4%-16% of the total mass of the system of the polyacrylonitrile casting solution, or the mixed solution that is mixed by the PVP and the Tween 80 accounting for 1%-5% of the total mass of the system of the polyacrylonitrile casting solution;

(3) preprocessing a surface of a reinforcement, comprising a step of:

infiltrating the polyacrylonitrile fiber hollow braided tube prepared in the Step (1) by weak polar organic liquid, so that an external surface of the polyacrylonitrile fiber hollow braided tube is fully infiltrated; wherein an infiltrating time of the polyacrylonitrile fiber hollow braided tube is is-60 s;

wherein, the weak polar organic liquid and the polyacrylonitrile fiber are insoluble; specifically, the weak polar organic liquid is ethanol, glycerol, isopropanol, or polyethylene glycol (PEG)-600; and

(4). preparing a hollow fiber membrane, comprising steps of:

processing the polyacrylonitrile fiber hollow braided tube obtained in the Step (3) and the polyacrylonitrile casting solution prepared in the Step (2) with a coextrusion by an annular spinneret, according to a sheath-core composite spinning technology, in such a manner that the polyacrylonitrile casting solution is equably coated on a surface of the polyacrylonitrile fiber hollow braided tube;

processing the polyacrylonitrile fiber hollow braided tube by air bath for 0 s-480 s;

dipping the polyacrylonitrile fiber hollow braided tube in coagulation bath of 10° C.-65° C.; and

fully solidifying the polyacrylonitrile fiber hollow braided tube, in such a manner that an enhanced-type polyacrylonitrile hollow fiber membrane is obtained;

wherein media of the coagulation bath is water, or the aqueous solution of the solvent;

wherein the scope of the mass percent of the solvent is 0%-100%, preferably, 0%-50%.

An enhanced-type hollow fiber membrane appearing earliest is polyvinylidene fluoride (PVDF) hollow fiber membrane, with a purpose to enhance a breaking strength of the PVDF hollow fiber membrane produced by a solution spinning method. At present, no applicable PVDF fiber (filament) is on sell, so other materials, such as polyester and polyamide fiber are used to produce a hollow braided fabric to be the reinforcement. Comparing with a PVDF hollow fiber membrane produced by a conventional monoplasmatic solution spinning method, an enhanced efficiency of a heterogeneous hollow braided fabric is effective and obvious, but an interfacial bounding condition between an external separation layer and the reinforcement is not good, so a reliability of a membrane operation system is poor. Therefore, as mentioned above, using conventional fiber and changing a geometric shape of the reinforcement and an embedded mode of the reinforcement to improve an interfacial bounding strength between the external separation layer of the heterogeneous enhanced-type PVDF hollow fiber membrane and the reinforcement thereof are reported more often. If a homogeneous enhanced-typed hollow fiber membrane is designed and prepared in preparing fiber and a hollow braided tube, coating a surface (compounding and solidifying) and post-processing, although a problem of the low interfacial bounding strength can be solved effectively, a whole process is complicated, and a cost of a manufacture is high, which is difficult to be used in practical.

The present invention is derived from conventional preparation methods of heterogeneous enhanced-type hollow fiber membranes, using polyacrylonitrile fiber on sell as a hollow braided fabric (the reinforcement), polyacrylonitrile casting solution whose cost is low is compositely solidified on the surface of the reinforcement to produce a homogeneous enhanced-type polyacrylonitrile hollow fiber membrane, wherein, the cost of materials of the homogeneous enhanced-type polyacrylonitrile hollow fiber membrane is low, and a mechanical property thereof is obviously higher than a monoplasmatic polyacrylonitrile hollow fiber membrane produced by the solution spinning method, so a scope of a use thereof can be expanded.

The preparation method of the present invention uses a technology of a homogeneous enhancement or a noumenal enhancement, i.e., the external separation layer of the hollow fiber membrane and the reinforcement thereof are formed by same or similar components, wherein, membrane-forming materials of casting solution and the reinforcement are both polyacrylonitrile, so that matrix phase material of an internal layer and an external layer of the hollow fiber membrane obtained do not have a compatibility difference; the internal layer and the external layer are combined closer, have an excellent interfacial bounding condition, a high interfacial bonding strength, and a high peel strength; problems that the external separation layer of the heterogeneous enhanced-type hollow fiber membrane and a basement membrane thereof, or the external separation layer thereof and the reinforcement thereof are separated or stripped when regenerating and backwashing, which causes that the hollow fiber membrane is physically damaged and an efficiency of a separation system of the hollow fiber membrane is lost can be effectively avoided. Main component of the external separation layer of the hollow fiber membrane obtained and the main component of the reinforcement thereof (a hollow braided tube) are both polyacrylonitrile, which belongs to a homogeneous enhanced-type hollow fiber membrane, so that the external separation layer of the hollow fiber membrane obtained and the reinforcement thereof have the excellent interfacial bounding condition and the high interfacial bounding strength. Therefore, the homogeneous enhanced-type hollow fiber membrane not only has a high breaking strength, but also has the high peel strength, and a mechanical property of the hollow fiber membrane is effectively improved, and an usable range thereof is increased. The hollow fiber membrane of the present invention has a characteristic that the mechanical property of a two-dimensional braided fabric is excellent, so an anti-tensile property of the hollow fiber membrane and an anti-compaction performance thereof are increased, and a service life thereof is prolonged. Meanwhile, a key of the present invention is to use weak polar organic liquid to fully infiltrate an external surface of the hollow braided tube, and the compatibility among the weak polar organic liquid used, a casting solution system, and the hollow braided fabric is good; in a process of coagulating, the weak polar organic liquid can be completely dissolved in coagulation bath, which does not affect the interfacial bounding strength between the external separation layer of the hollow fiber membrane and the reinforcement thereof; in the process of compounding, the weak polar organic liquid can make solvent component that are existed in polyacrylonitrile casting solution to appropriately dissolve and erode a fiber structure of the hollow braided tube, in order to make the polyacrylonitrile casting solution and the hollow braided tube combine closer, the fiber structure of the hollow braided tube appropriately eroded does not damage a main structure of the hollow braided tube, and guarantees a completeness of the main structure of the hollow braided tube, for keeping the excellent mechanical property. In addition, along with a quickly expanded marketing of products of membrane bioreactor (MBR) technology, a treatment of obsoleted membrane materials of the MBR technology is gradually becoming a major recourse and environmental problem to be solved. Comparing with heterogeneous enhanced-type membrane materials, the preparation method of the enhanced-type polyacrylonitrile hollow fiber membrane designed by the present invention is the preparation method of the homogeneous enhanced-type polyacrylonitrile hollow fiber membrane, so the enhanced-type polyacrylonitrile hollow fiber membrane obtained is the homogeneous enhanced-type polyacrylonitrile hollow fiber membrane, wherein the obsoleted membrane materials generated in the process of spinning, membrane-forming, and an application in an reality are easy to be recycled and be reused, which is good for a recycling of recourses and thus is a green technology.

The preparation method of the present invention can produce the homogeneous enhanced-type polyacrylonitrile hollow fiber membrane directly, wherein, the breaking strength of the homogeneous enhanced-type polyacrylonitrile hollow fiber membrane is >400 N; a biggest pore size thereof is not smaller than 3.0 μm; when the homogeneous enhanced-type polyacrylonitrile hollow fiber membrane is backwashed continuously under 0.1 MPa for 4 h, the external layer and the internal layer are not separated.

Some aspects that are not described in the present invention are applied in a conventional technology.

Examples of the present invention are described as follows, but the examples only use to further explain a technology of the present invention, but do not limit a protection scope of claims of the present invention.

### EXAMPLE 1

(1) Polyacrylonitrile fiber filament is knitted by a two-dimensional weaving technology to be a polyacrylonitrile fiber hollow braided tube, and a breaking strength of the polyacrylonitrile fiber hollow braided tube is 540.4 N.

(2) Polyacrylonitrile resin accounting for 11% of a total mass of a system, DMSO accounting for 80% of the total mass of the system, PVP accounting for 7% of the total mass of the system, and Tween 80 of 2% of the total mass of the system are mixed, dissolved equably, and processed with a deaeration, in such a manner that polyacrylonitrile casting solution is obtained.

(3) The polyacrylonitrile fiber hollow braided tube obtained in the Step (1) is infiltrated by ethanol, wherein a time of the polyacrylonitrile fiber hollow braided tube infiltrated is 1 s.

(4) According to a sheath-core composite spinning technology, the polyacrylonitrile fiber hollow braided tube obtained in the Step (3) is utilized as a reinforcement, and is processed with a coextrusion by an annular spinneret together with the polyacrylonitrile casting solution obtained in the Step (2), in such a manner that the polyacrylonitrile casting solution is equably coated on a surface of the polyacrylonitrile fiber hollow braided tube; the polyacrylonitrile fiber hollow braided tube is processed by air bath for 1 min; the polyacrylonitrile fiber hollow braided tube is dipped into water of 40° C. to be fully solidified; in such a manner that an enhanced-type polyacrylonitrile hollow fiber membrane is obtained.

The breaking strength of the enhanced-type polyacrylonitrile hollow fiber membrane obtained is measured to be 455.1 N, and a biggest pore size thereof is measured to be 3.434 μm. When the enhanced-type polyacrylonitrile hollow fiber membrane obtained is backwashed continuously under 0.1 MPa for 4 h, an internal layer thereof and an external layer thereof are not separated.

### EXAMPLE 2

(1) Polyacrylonitrile fiber filament is knitted by a two-dimensional weaving technology to be a polyacrylonitrile fiber hollow braided tube, and a breaking strength of the polyacrylonitrile fiber hollow braided tube is 540.4 N.

(2) Polyacrylonitrile resin accounting for 12% of a total mass of a system, DMF accounting for 79% of the total mass of the system, PVP accounting for 8% of the total mass of the system, and Tween 80 accounting for 1% of the total mass of the system are mixed, dissolved equably, and processed with a deaeration, in such a manner that polyacrylonitrile casting solution is obtained.

(3) The polyacrylonitrile fiber hollow braided tube obtained in the Step (1) is infiltrated by ethanol, wherein a time of the polyacrylonitrile fiber hollow braided tube infiltrated is 60 s.

(4) According to a sheath-core composite spinning technology, the polyacrylonitrile fiber hollow braided tube obtained in the Step (3) is used as a reinforcement, and is processed with a coextrusion by an annular spinneret together with the polyacrylonitrile casting solution obtained in the Step (2), in such a manner that the polyacrylonitrile casting solution is equably coated on a surface of the polyacrylonitrile fiber hollow braided tube; the polyacrylonitrile fiber hollow braided tube that is coated with the polyacrylonitrile casting solution is quickly dipped into water of 60° C. to be fully solidified; in such a manner that an enhanced-type polyacrylonitrile hollow fiber membrane is obtained.

The breaking strength of the enhanced-type polyacrylonitrile hollow fiber membrane obtained is measured to be 523 N, and a biggest pore size thereof is measured to be 4.058 μm. When the enhanced-type polyacrylonitrile hollow fiber membrane obtained is backwashed continuously for 4 h under 0.1 MPa, an internal layer thereof and an external layer thereof are not separated.

### EXAMPLE 3

(1) Polyacrylonitrile fiber filament is knitted by a two-dimensional weaving technology to be a polyacrylonitrile fiber hollow braided tube, and a breaking strength of the polyacrylonitrile fiber hollow braided tube is 540.4 N.

(2) Polyacrylonitrile resin accounting for 9% of a total mass of a system, N, N-dimethylacetamide accounting for 81% of the total mass of the system, PEG-600 accounting for 8% of the total mass of the system, and Tween 80 accounting for 2% of the total mass of the system are mixed, dissolved equably, and processed with a deaeration, in such a manner that polyacrylonitrile casting solution is obtained.

(3) The polyacrylonitrile fiber hollow braided tube obtained in the Step (1) is infiltrated by ethanol, wherein a time of the polyacrylonitrile fiber hollow braided tube infiltrated is 5 s.

(4) According to a sheath-core composite spinning technology, the polyacrylonitrile fiber hollow braided tube obtained in the Step (3) is utilized as a reinforcement, and is processed with a coextrusion by an annular spinneret together with the polyacrylonitrile casting solution obtained in the Step (2), in such a manner that the polyacrylonitrile casting solution is equably coated on a surface of the polyacrylonitrile fiber hollow braided tube; the polyacrylonitrile fiber hollow braided tube that is coated with the polyacrylonitrile casting solution is quickly dipped into water of 40° C. to be fully solidified, in such a manner that an enhanced-type polyacrylonitrile hollow fiber membrane is obtained.

The breaking strength of the enhanced-type polyacrylonitrile hollow fiber membrane obtained is measured to be 465 N, and a biggest pore size thereof is measured to be 4.251 μm. When the enhanced-type polyacrylonitrile hollow fiber membrane obtained is backwashed continuously for 4 h under 0.1 MPa, an internal layer thereof and an external layer thereof are not separated.

### EXAMPLE 4

(1) Polyacrylonitrile fiber filament is knitted by a two-dimensional weaving technology to be a polyacrylonitrile fiber hollow braided tube, and a breaking strength of the polyacrylonitrile fiber hollow braided tube is 540.4 N.

(2) Polyacrylonitrile resin accounting for 12% of a total mass of a system, NMP accounting for 79% of the total mass of the system, PEG-600 accounting for 7% of the total mass of the system, and Tween 80 accounting for 2% of the total mass of the system are mixed, dissolved equably, and processed with a deaeration, in such a manner that polyacrylonitrile casting solution is obtained.

(3) The polyacrylonitrile fiber hollow braided tube obtained in the Step (1) is infiltrated by ethanol, wherein a time of the polyacrylonitrile fiber hollow braided tube infiltrated is 20 s.

(4) According to a sheath-core composite spinning technology, the polyacrylonitrile fiber hollow braided tube obtained in the Step (3) is utilized as a reinforcement, and is processed with a coextrusion by an annular spinneret together with the polyacrylonitrile casting solution obtained in the Step (2), in such a manner that the polyacrylonitrile casting solution is equably coated on a surface of the polyacrylonitrile fiber hollow braided tube; the polyacrylonitrile fiber hollow braided tube is processed by air bath for 1 min; the polyacrylonitrile fiber hollow braided tube is dipped into water of 60° C. to be fully solidified; in such a manner that an enhanced-type polyacrylonitrile hollow fiber membrane is obtained.

The breaking strength of the enhanced-type polyacrylonitrile hollow fiber membrane obtained is 504 N, and a biggest pore size thereof is 4.464 μm. When the enhanced-type polyacrylonitrile hollow fiber membrane obtained is backwashed continuously for 4 h under 0.1 MPa, an internal layer thereof and an external layer thereof are not separated.

### EXAMPLE 5

(1) Polyacrylonitrile fiber filament is knitted by a two-dimensional weaving technology to be a polyacrylonitrile fiber hollow braided tube, and a breaking strength of the polyacrylonitrile fiber hollow braided tube is 540.4 N.

(2) Polyacrylonitrile resin of 16% of a total mass of a system, NMP accounting for 79% of the total mass of the system, PEG-600 of 5% of the total mass of the system, and Tween 80 accounting for 2% of the total mass of the system are mixed, dissolved equably, and processed with a deaeration, in such a manner that polyacrylonitrile casting solution is obtained.

(3) The polyacrylonitrile fiber hollow braided tube obtained in the Step (1) is infiltrated by ethanol, wherein a time of the polyacrylonitrile fiber hollow braided tube infiltrated is 20 s.

(4) According to a sheath-core composite spinning technology, the polyacrylonitrile fiber hollow braided tube obtained in the Step (3) is utilized as a reinforcement, and is processed with a coextrusion by an annular spinneret together with the polyacrylonitrile casting solution obtained in the Step (2), in such a manner that the polyacrylonitrile casting solution is equably coated on a surface of the polyacrylonitrile fiber hollow braided tube; the polyacrylonitrile fiber hollow braided tube is processed by air bath for 1 min; the polyacrylonitrile fiber hollow braided tube that is coated with the polyacrylonitrile casting solution is dipped into water of 60° C. to be fully solidified; in such a manner that an enhanced-type polyacrylonitrile hollow fiber membrane is obtained.

The breaking strength of the enhanced-type polyacrylonitrile hollow fiber membrane obtained is measured to be 487 N, and a biggest pore size thereof is measured to be 4.699 μm. When the enhanced-type polyacrylonitrile hollow fiber membrane obtained is backwashed continuously for 4 h under 0.1 MPa, an internal layer thereof and an external layer thereof are not separated.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A preparation method of an enhanced-type polyacrylonitrile hollow fiber membrane, comprising steps of:
(1) knitting a polyacrylonitrile fiber reinforcement, comprising a step of:
knitting polyacrylonitrile fiber to be a polyacrylonitrile fiber hollow braided tube by a two-dimensional weaving technology;
wherein the polyacrylonitrile fiber hollow braided tube is utilized as a reinforcement of a hollow fiber membrane;
(2) preparing polyacrylonitrile casting solution, comprising a step of:
mixedly dissolving the polyacrylonitrile resin and the additive in solvent;
wherein, a system of the polyacrylonitrile casting solution comprises:
the polyacrylonitrile resin: 3%-25% in mass fraction;
the solvent: 50%-95% in mass fraction;
and the additive: 2%-30% in mass fraction;
wherein a sum of the mass fraction of all composition mentioned above is 100%;
wherein, the polyacrylonitrile resin is conventional fiber-forming polyacrylonitrile resin; the solvent is a good type solvent of polyacrylonitrile, which is selected from a group consisting of N,N-dimethylformamide (DMF), N,N-dimethylacetamide, dimethyl sulfoxide (DMSO), N-Methyl-2-pyrrolidone (NMP), and aqueous solution of sodium thiocyanate of 55 wt %; the additive is water-soluble components, which is mixed solution of polyethylene glycol (PEG) or polyvinylpyrrolidone (PVP) accounting for 2%-25% of the total mass of the system of the polyacrylonitrile casting solution and Tween 80 accounting for 0%-10% of the total mass of the system of the polyacrylonitrile casting solution;
(3) preprocessing a surface of reinforcement, comprising a step of:
infiltrating the polyacrylonitrile fiber hollow braided tube prepared in the Step (1) by weak polar organic liquid, in such a manner that an external surface of the polyacrylonitrile fiber hollow braided tube is fully infiltrated; wherein an infiltrating time of the polyacrylonitrile fiber hollow braided tube is 1 s-60 s;
wherein the weak polar organic liquid is ethanol, glycerol, is opropanol, or polyethylene glycol (PEG)-600; and
(4) preparing a hollow fiber membrane, comprising steps of:
processing the polyacrylonitrile fiber hollow braided tube obtained in the Step (3) and the polyacrylonitrile casting solution prepared in the Step (2) with a coextrusion by an annular spinneret, according to a sheath-core composite spinning technology, in such a manner that the polyacrylonitrile casting solution is equably coated on a surface of the polyacrylonitrile fiber hollow braided tube;
processing the polyacrylonitrile fiber hollow braided tube by air bath for 0 s-480 s;
dipping the polyacrylonitrile fiber hollow braided tube in coagulation bath of 10° C.-65° C.; and
fully solidifying the polyacrylonitrile fiber hollow braided tube;
in such a manner that an enhanced-type polyacrylonitrile hollow fiber membrane is obtained;
wherein media of the coagulation bath is water, or the aqueous solution of the solvent;
wherein a scope of a mass percent of the solvent is 0%-100%.

2. The preparation method of the enhanced-type polyacrylonitrile hollow fiber membrane, as recited in claim 1, wherein the system of the polyacrylonitrile casting solution comprises:
the polyacrylonitrile resin: 7%-14% in mass fraction;
the solvent: 70%-89% in mass fraction; and
the additive: 4%-16% in mass fraction;
wherein a sum of the mass percent of all composition mentioned above is 100%.

3. The preparation method of the enhanced-type polyacrylonitrile hollow fiber membrane, as recited in claim 1, wherein the additive is the mixed solution of the PEG or the PVP accounting for 4%-16% of the total mass of the system of the polyacrylonitrile casting solution and the Tween 80 accounting for 1%-5% of the total mass of the system of the polyacrylonitrile casting solution.

4. The preparation method of the enhanced-type polyacrylonitrile hollow fiber membrane, as recited in claim 1, wherein the solvent of the coagulation bath is 0%-50% in mass fraction.

5. An enhanced-type polyacrylonitrile hollow fiber membrane, prepared according to the preparation method of the enhanced-type polyacrylonitrile hollow fiber membrane of claim 1, wherein said enhanced-type polyacrylonitrile hollow fiber membrane is a homogeneous enhanced-type polyacrylonitrile hollow fiber membrane; a breaking strength of said homogeneous enhanced-type polyacrylonitrile hollow fiber membrane is >400 N; a maximum pore size thereof is not less than 3.0 μm.
